(19) United States
(12) Patent Application Publication
(10) Pub. No.: US 2005/0279595 A1
(43) Pub. Date: Dec. 22, 2005

(54) Refrigerant-cooled rotor

(76) Inventors: John Kallenbach, Weddington, NC (US); James P. Kallenbach, Weddington, NC (US)

Correspondence Address: SUMMA & ALLAN, P.A., 11610 NORTH COMMUNITY HOUSE ROAD, SUITE 200, CHARLOTTE, NC, 28277, US

(21) Appl. No.: 10/869,272

(22) Filed: Jun. 16, 2004

(51) Int. Cl. F16D 65/78

(52) U.S. Cl. 188/264 D; 188/264 R

(57) ABSTRACT

The invention is a refrigerant cooled rotor and an associated method and system of cooling a rotor. The rotor at issue is an at least partially hollow annular enclosure with the refrigerant housed in the enclosure. The rotor is typically used to provide a surface against which another device comes into frictional contact. The refrigerant absorbs and releases the frictional heat on the rotor surface in a continuous heat transfer cycle to limit the maximum rotor temperature. By vaporizing and condensing the refrigerant inside the rotor, the refrigerant provides a regenerative heat sink for cooling.

### BACKGROUND

Mechanical devices often include surfaces subject to heat. Many apparatuses must be made of a durable material that conducts the heat from one surface to other regions of the device. A problem occurs when the heat has no outlet for cooling the device, causing the temperature of the device to continuously escalate. The material, which is likely a metal or an alloy of various metals, has a critical temperature at which the metal will suffer a physical breakdown by cracking, melting, or wearing away. Most mechanical designs must, therefore, include a way of cooling surfaces to prolong the useful life of a device subject to heat.

One of the main sources of heat in mechanical operations is the force of friction. Interoperability of parts almost always means that surfaces within a mechanical structure touch and interact. The contact between parts produces friction, which, in turn, increases the temperature of the touching surfaces.

One common problem in mechanical design is that of cooling frictional heat without interrupting performance. For example, rotors provide a friction bearing surface in mechanical devices such as brakes and clutches. Cooling these surfaces with water or other refrigerants is difficult because water also changes the coefficient of friction necessary for the rotor to serve a useful purpose. The problem is particularly acute in rotors for automotive brakes.

Disc brake rotors are a common part of modern motor vehicle brake assemblies. Disc brake rotors work with other components of a vehicle's brake system to slow, stop, or maintain the vehicle in a stopped position.

One of the biggest problems with brake rotors is that the extreme force of friction on the rotor leads to mechanical failure. A rotor is typically made of steel or other metal alloys that have a critical temperature, above which the material will fail. As a rotor contacts a braking device, the friction rapidly increases the temperature of the rotor body. These frictional forces eventually wear away the body of the rotor. This wear is exacerbated because the heat generated by friction weakens the material of the rotor body. Cooling a rotor is an integral part of designing modern braking systems, such as those used in the automotive industry today.

Some modern disc brake rotors are vented with holes to allow air flow and accordingly remove heat. Venting disc brake rotors in this manner, however, lowers the surface area of the rotor available to interact with a brake pad and thus slow or stop the vehicle.

Another mechanism for maintaining lower disc brake rotor temperature includes the use of liquids in various ways. For example, U.S. Pat. No. 2,518,016 issued to Johnson, et al., discloses a disc-type brake operated by pressurized air or other fluid and adapted to be cooled by any suitable cooling medium. The cooling medium is positively circulated through the discs using a pump. The '016 patent also teaches the use of a dump valve to release the cooling liquid from the brake housing. Pumps and valves, however, are prone to failure, which could render the stopping mechanism inoperative.

Another example is U.S. Pat. No. 3,044,736 issued to Chambers for liquid cooled friction brakes. The '736 patent teaches the use of liquid sprayed onto the friction elements of the brake. Subsequently, friction from use of the brake vaporizes the liquid and carries heat away. One drawback to this invention is the use of water on frictional elements of a brake. Water lowers the coefficient of friction between the frictional elements, thus defeating the purpose of the brake. In addition, the invention of the '736 patent requires constant maintenance of the water level in a reservoir dedicated for this purpose.

U.S. Pat. No. 3,516,522 issued to Chamberlain discloses a liquid cooled wheel and brake assembly. The Chamberlain rotor includes a subdivided liquid chamber having a plurality of radially spaced annular fins. The rotor also includes a complex valve system to release pressure that builds up as liquid vaporizes in the chamber. The valve system of the Chamberlain '522 patent complicates the overall design and leads to a higher possibility of failure. If the valve system leaks, the liquid inside will not serve its intended purpose and the brake will overheat. If the valve fails to open, the pressure inside the brake assembly may cause brake failure.

Yet another example is U.S. Pat. No. 4,242,609 to Burenkov, et al., for a water-cooled electromagnetic brake. The '609 patent teaches the use of an intricate forced delivery system to place cooling liquid around an excitation winding and other heat transfer areas. The '609 patent further teaches the requirement of a reverse-flow inhibition system for proper function.

U.S. Pat. No. 4,815,573, issued to Miyata, provides another example of using a liquid to cool a braking system. The Miyata disclosure shows a liquid cooled disc brake. The '573 patent teaches the use of a caliper with a hollow wall so that cooling liquid flows through it. The liquid circulates through a hollow portion of the caliper and requires a supply and discharge means.

Japanese patent abstract publication number 08-170669 to Matsukawa, et al., also shows a water-cooled disk brake. The abstract teaches the use of cooling water paths in the brake pad. The paths are formed along the rotational direction of the disk rotor.

Yet another example is U.S. Pat. No. 6,478,126 to Drecq for an eddy-current brake device. The '126 patent teaches the use of an eddy-current brake device including at least one heat-exchanger for dissipating thermal energy due to eddy currents during braking. The heat exchanger utilizes water circulating through circular ducts. This circulation system is subject to pressure differentials and turbulent coolant flow which can compromise the cooling efficiency of the device.

WIPO publication WO 03/089803 A1 by Nowak, et al., provides further disclosure of a fluid cooled brake housing. Nowak, et al., teaches the use of a fluid circulating through the brake housing to cool friction components within the housing. The brake housing includes a complex pump and heat exchange system. The brake housing further includes a separate volume of fluid sealed within the housing and partially covering the braking surface. As stated previously, braking surfaces covered with fluid lowers the coefficient of friction between the friction components of the brake, and may compromise their function.

U.S. Pat. No. 3,602,425, issued to Schmidt on Aug. 31, 1971 shows another means for cooling a friction bearing surface. The Schmidt '425 device includes a hermetically sealed container having thermally conductive walls partially filled with a volatile fluid. The container is stationary, and one of the thermally conductive walls is subject to friction from a rotating device contacting a container wall. The fluid inside the container cools the friction bearing wall by absorbing the frictional heat energy. The absorbed heat vaporizes the fluid in the container. The vapor moves away from the friction bearing wall, cools, and then condenses back to liquid form. In this manner, the volatile fluid provides a continuously regenerative heat transfer cycle. The Schmidt '425 patent cools a stationary object subject to friction, but provides no way of cooling a moving device, such as a rotor.

Thus, there is a need for a reliable, rugged, rotor that is cooled for superior performance and simplified in design and manufacture. In particular, there is a need for a rotor that uses a refrigerant for cooling without diminishing the rotor's friction bearing purpose in mechanical designs.

In this regard, cooling mechanisms have been used in other contexts without affecting the outer surfaces of an apparatus. For example, an instrument known as a heat pipe has been used to cool electrical devices. In the heat pipe, heat converts liquid methanol into a vapor, which travels the length of the inside of a closed pipe. At a cooler end, the vapor condenses into a liquid and wicks back to the hotter end via etched lines. A fan can be used to keep the cooler end at a lower temperature. See Machine Design, Volume 46, Apr. 3, 2003.

The heat pipe has also been used to dissipate frictional heat. In one drill design, a hollow passage is drilled into the drill shank, filled with water, and capped off. As the drill tip is exposed to friction and heats past the boiling point of the water, the water boils, vaporizes and travels up the shank within the hollow passage. The end of the shank opposite the drill tip is at a lower temperature than the tip. As the steam travels up the shank to the cooler end, the steam condenses back to a liquid form. The condensed water sinks back to the hotter part of the shank, thus providing a continuously regenerated heat sink. See Modern Machine Shop, May 2003, pages 56-57. The heat pipe, therefore, is an example of providing a continuously regenerative heat sink that cools a mechanical apparatus from the inside.

A need continues to exist for a rotor that is capable of being cooled from the inside surface while maintaining sufficient structural integrity to withstand the forces of friction and pressure to which a rotor is exposed during use.

### SUMMARY OF THE INVENTION

It is an object of the present invention to provide a rotor with an improved resistance to the detrimental effects of heat by sealing a coolant within an annular enclosure, thereby providing a heat sink therein.

It is further an object of the present invention to provide a simple, effective rotor with a cooling means requiring no heat exchangers, coolant circulation machinery, or valves.

It is further an object of the present invention to provide a disc brake rotor as a sealed annular cavity that is partially filled with a refrigerant to retard the detrimental effects of heat.

To meet these objectives, the present invention provides a substantially annular enclosure that spins around its axis with a refrigerant sealed inside the enclosure. When an adjustable braking device contacts the enclosure to slow the spinning rate, the refrigerant absorbs and then releases the frictional heat generated by the surfaces contacting one another. The refrigerant thereby limits the maximum temperature of the annular enclosure.

### BRIEF DESCRIPTION OF THE DRAWINGS

FIG. 1 is a front plan view of a rotor according to the invention.

FIG. 2 is a cross-sectional side view of the rotor shown in FIG. 3 with a refrigerant in the annular enclosure.

FIG. 3 is a front plan view of a rotor according to the invention with a refrigerant housed in the annular enclosure.

FIG. 4 is a cross-sectional side view of a rotor with the outer circumferential wall having the same radius as the rotor faceplates.

FIG. 5 is a front plan view of the rotor shown in FIG. 4.

FIG. 6 is a plan view of a tire assembly with a brake rotor installed therein.

FIG. 7 is an exploded view of the tire assembly of FIG. 6.

FIG. 8 is a side view of a braking assembly incorporating the rotor of the invention.

FIG. 9 is a side cross sectional view of a rotor according to this invention including a transfer ring with bored passages providing a path for vaporized refrigerant.

FIG. 10 is a front plan view of the rotor of FIG. 9 with a refrigerant filling the hollow portion inside the rotor and the associated transfer ring inside the rotor.

FIG. 11 is a top view of the bored transfer ring inside the rotor of FIG. 10, taking from the outermost hollow space within the rotor.

FIG. 12 is a plotted graph of rotor temperature per unit time for a standard rotor and the rotor of this invention.

FIG. 13 is a plotted graph of rotor temperatures for a standard rotor and a refrigerant filled rotor according to this invention as varied by brake pressure on the rotor.

FIG. 14 is a plotted graph of rotor temperatures for a standard rotor and a refrigerant filled rotor according to this invention as varied by brake pressure at the noted speeds.

### DETAILED DESCRIPTION

The invention is a rotor (10) for contacting a frictional device and an associated method of cooling the rotor. As used herein, the term rotor includes, without limitation, any device that provides a friction bearing surface for changing the rate of movement, particularly slowing or stopping movement, by contacting the friction bearing surface with another surface. Traditionally, a rotor is an annular ring that spins along with another device, such as an automobile wheel.

A frictional device contacts the rotor, exerts pressure and therefore friction on the rotor, and typically slows or stops the connected apparatus. As used herein and without limiting the scope of the invention, the term “frictional device” is any device that contacts the rotor (10) to exert friction on the rotor (10) to change the rotor (10) velocity. A frictional device includes, but is not limited to, the brake pads in traditional automotive braking systems. References to brake pads, as used herein, are meant for illustration, without limiting the types of frictional devices that may be used in accordance with this invention.

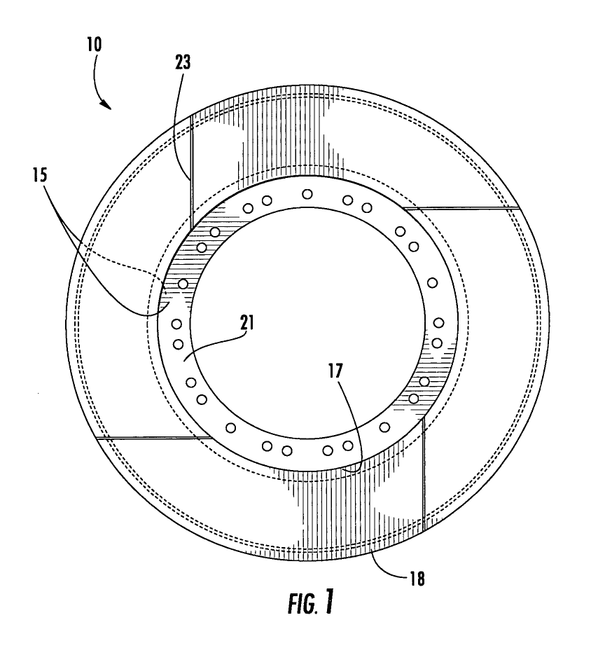

As shown in FIG. 1, the rotor (10) is a substantially annular enclosure (15) with a first faceplate (24) and a second faceplate (25) connected by an inner circumferential wall (17) and an outer circumferential wall (18). The first and second faceplates (24, 25) provide a friction bearing surface for contacting a frictional device. An inner flange (21) is connected substantially perpendicularly to the inner circumferential wall (17) and provides a means of attaching the rotor to a mechanical system. The rotor may optionally include air grooves (23) which prevent air pockets from interfering with the friction bearing faceplate of the rotor.

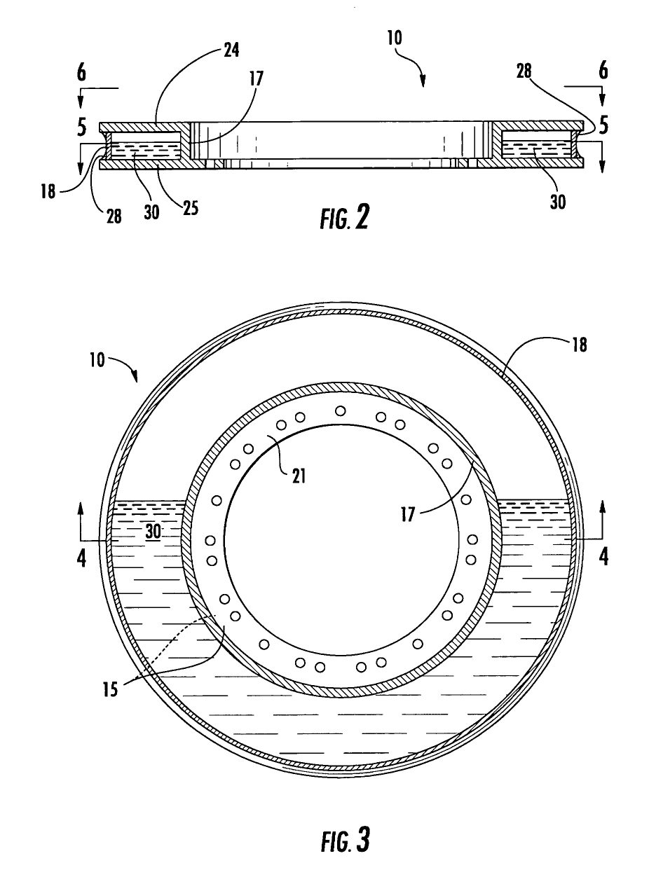

FIGS. 2 and 3 show that the physical structure of the rotor (10) may include features that enhance durability. For example, the radius of the outer circumferential wall (18), taken from the center axis of the annular enclosure (15), is less than the radius of the first and second faceplates (24, 25). This dimensional aspect of the invention allows for a reinforced weld (28) to connect the outer circumferential wall (18) to the first and second faceplates (24, 25). The rotor (10) may optionally include contoured outer edges along the first and second faceplates (24, 25) to increase surface area. The increased surface area allows more heat to dissipate across the rotor (10) into the ambient atmosphere. Similarly, the outer circumferential wall (18) may be contoured to maximize surface area as well.

As shown in FIG. 3, the rotor is at least partially hollow. The inner circumferential wall (17), the outer circumferential wall (18), the first faceplate (24), and the second faceplate (25) are connected to define an annular cavity inside the annular enclosure (15) of the rotor (10). A refrigerant (30) at least partially fills the cavity, according to the invention herein. The refrigerant can by any material capable of absorbing heat. Liquids such as propylene glycol are suitable for this purpose. Other suitable refrigerants are also available. In a preferred embodiment, the refrigerant is water. The refrigerant may be a mixture of various refrigerants such as water and propylene glycol.

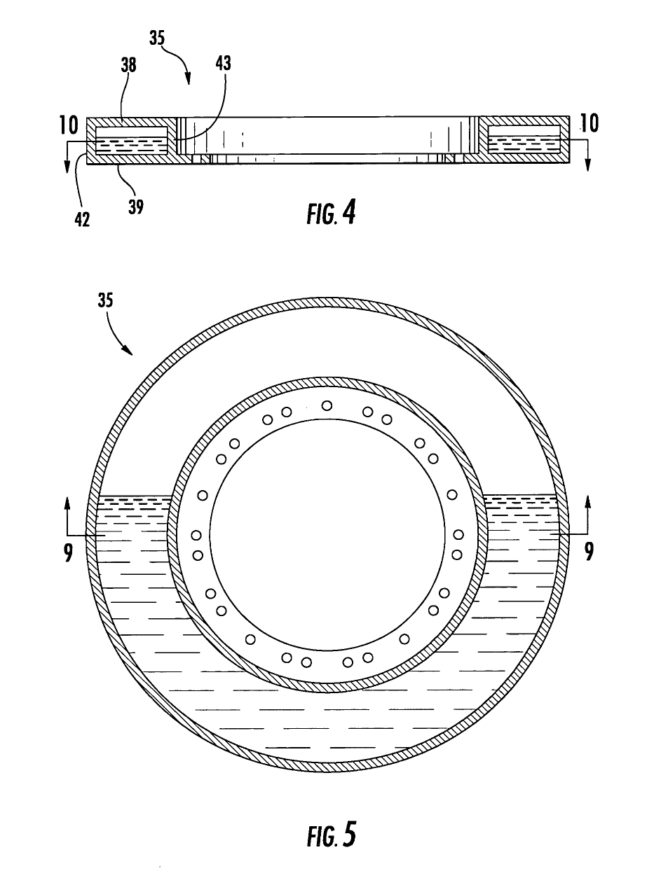

FIGS. 4 and 5 show another rotor (35) according to the invention herein. The rotor (35) of FIGS. 4 and 5 is also a refrigerant-filled rotor. In this embodiment, however, the first and second faceplates (38, 39) meet the outer circumferential wall (42) at an angle of about 90 degrees. In other words, the outermost radius of the first and second faceplates (38, 39) taken from the center of the rotor (35), is equal to the outermost radius of the outer circumferential wall (42).

The rotors of FIGS. 1-5 are useful in a wide variety of applications. Industrial braking systems often use rotors for a friction bearing surface. One of the most widely known uses for a rotor, however, is within an automotive context. A rotor in this environment may be a brake rotor or even a rotor in a clutch system. Without limiting the scope of the invention, the operation of the rotor of this invention may be described in terms of an automobile brake rotor.

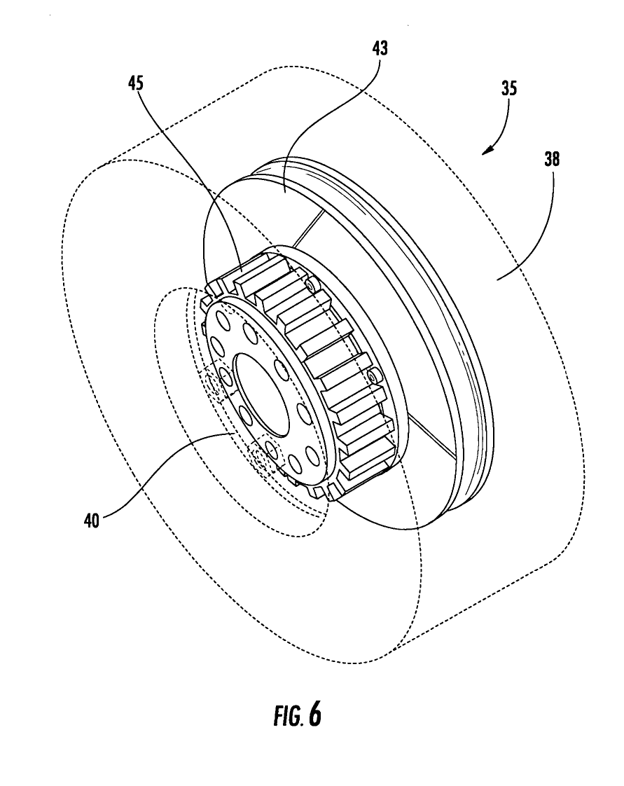

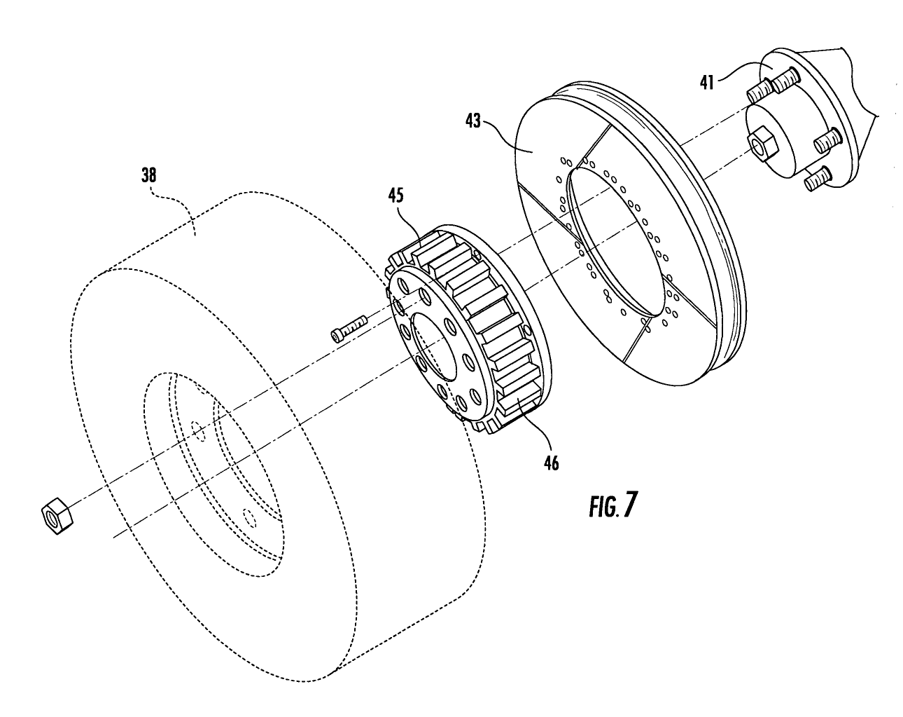

Braking systems are common in the field of automotive technology and will only be described in general herein. In a traditional automobile, the driver has a brake pedal which controls, in part, the braking of a wheel assembly as shown in FIGS. 6 and 7. The wheel assembly generally includes an inflated tire (38) around a tire rim (40). A spindle (41) connects to the tire rim (40) and a brake rotor (43) as part of the wheel assembly. The spindle rotates the rotor (43) around its axis. An optional cooling attachment, known as a hat (45), provides a heat sink from the rotor (43) to assist in cooling the brake rotor (43) during use.

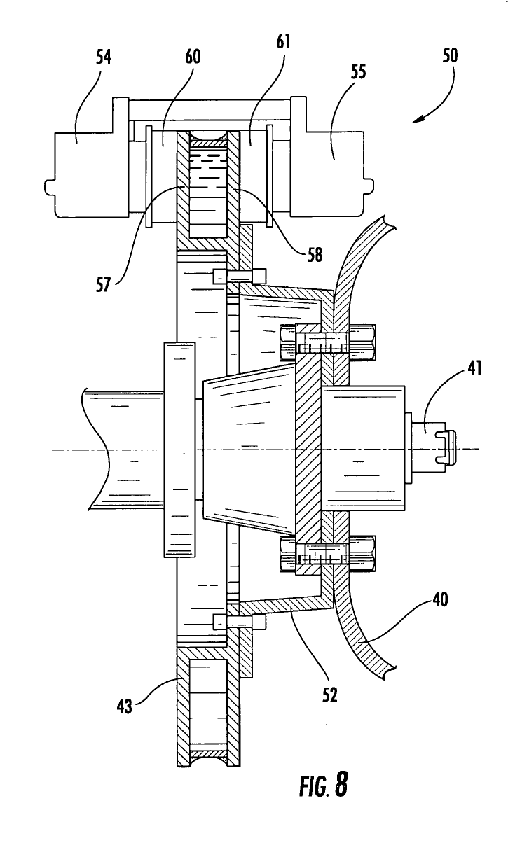

FIG. 8 shows an example braking assembly for the rotating wheel structure of FIGS. 6 and 7. The braking system (50) includes a hub (52) connecting the spindle (41) with the brake rotor (43) and the tire rim (40) integrally connected as shown. When the driver presses a brake pedal, the braking system (not shown) forces the calipers (54, 55) to squeeze the brake pads (60, 61) so that the brake pads (60, 61) contact the faceplates (57, 58) of the brake rotor (43). The friction between the brake pads (60, 61) and the brake rotor faceplates (57, 58) slows or stops the car, depending on the duration of the pressure exerted by the calipers (54, 55) on the brake pads (60, 61). The invention herein includes a cooling mechanism for the brake rotor (43) that conducts frictional heat from the brake pads (60, 61).

Typically, the brake rotor (43) is made of a metal, or a metal alloy, such as steel. The body of the brake rotor (43), therefore, conducts heat from the friction bearing faceplates (57, 58) across the connected surfaces of the rotor (43). As the frictional devices, such as brake pads (60, 61) press against the rotor (43), the rotor temperature increases until the brake pads (60, 61) are removed from contact with the rotor (43). Continual pressure on the rotor (43) from the brake pads (60, 61) yields more friction, a higher temperature, and more heat energy that must be either absorbed by the rotor or released into a heat sink. In standard brake rotors of the prior art, an escalating temperature of the material making up the rotor body increases the probability that the rotor (43) will suffer a mechanical failure, such as a crack or a hole.

Referring generally to FIGS. 1-5, the invention incorporates a way of cooling a rotor (10) as a frictional device increases the rotor temperature. For cooling purposes, the rotor is at least partially filled with a refrigerant (30) inside the annular enclosure (15). The volume of the refrigerant (30) is at least half of the volume of the annular enclosure, preferably between about 50 percent and about 80 percent of the volume of the annular enclosure (15). In a more preferred embodiment, the volume of refrigerant (30) is between about 55 percent and 65 percent of the volume of the annular enclosure.

The refrigerant (30), also known as a coolant, can be any material that is capable of absorbing the heat energy within the rotor body (10) during periods of contact with the frictional device, such as brake pads (60, 61). In a preferred embodiment, the refrigerant is a liquid. In a more preferred embodiment, the refrigerant is water. Known refrigerants may be mixed for use herein as well.

Placing water within the hollow annular enclosure (15) provides a stable and reliable refrigerant (30) for cooling the rotor (10) of the instant invention. As a frictional device contacts the rotor (10), the rotor increases in temperature because the frictional heat conducts across the entire rotor (10). If the frictional device is removed from the rotor (10) for a sufficiently long period of time, the rotor (10) will cool due to the rotor (10) rotating in an ambient atmosphere, allowing the heat to dissipate. Many situations arise, however, in which the rotor is given less opportunity to cool in an ambient atmosphere. The invention herein provides a refrigerant inside the rotor (10) to help cool the rotor in those situations.

The refrigerant (30) is vaporizable and condensable to accomplish the purposes of the instant invention. The refrigerant (30) preferably has a high heat of vaporization that allows the refrigerant (30) to absorb a large amount of heat energy before vaporizing. The friction exerted by a device contacting the faceplates (24, 25) of the rotor (10) causes the rotor temperature to escalate. The refrigerant (30) within the rotor absorbs this heat energy from the rotor body (10), thereby increasing the temperature of the refrigerant (30). Continuing to absorb frictional heat from the rotor causes the refrigerant (30) to eventually reach the refrigerant's vaporization temperature, converting the liquid refrigerant into a gaseous state. The gaseous refrigerant then holds some of the energy imparted by frictional contact on the rotor (10).

The rotor (10) is cooled by the liquid refrigerant absorbing the heat of friction. The rotor may be further cooled by the ambient atmosphere around the rotor providing a heat sink in which the rotor dissipates heat. Alternatively, the pressure of the frictional device contacting the rotor may be reduced or even removed to eliminate the force of friction on the rotor body. In any one of these cases, the rotor (10) is allowed to cool.

Although the inventors do not wish to be limited to any one theory of operation, the cooling process continues as follows. After vaporizing within the annular enclosure (15) of the rotor body (10), the refrigerant (30) exchanges the absorbed heat within the vapor back to cooler sections of the rotor body. In most circumstances, the rotor body has been cooled by the liquid, non-vaporized refrigerant, the ambient atmosphere, an attached heat sink, or by removing the force of friction on the rotor (10). The cooler body of the rotor (10) allows the vaporized refrigerant (30) to exchange heat back to the rotor (10), which dissipates the heat into the ambient atmosphere at a rapid rate.

In this embodiment, the refrigerant (30) inside the rotor (10) cools the rotor for a sufficient amount of time to allow the rotor (10) to continue operating without failing. The refrigerant (30) gives the rotor (10) sufficient relief from the heat of friction to allow time for conditions in which the rotor operates to change and provide further cooling. For example, extended periods of braking are often followed by a period of no frictional contact. The refrigerant (30) cools the rotor during an extended period of braking so the rotor (10) can continue to function until reaching a less stressful period of no frictional contact.

The rotor (10) described above incorporates a new method of cooling a mechanical device subject to heat on a surface. Without limiting the invention, the method is particularly adept in cooling a brake rotor (43). The invention includes a step of partially filling the cavity of a sealed annular enclosure (15) with a refrigerant (30). In a preferred embodiment, the refrigerant is water. The cooling method includes spinning the rotor (10) around its axis to centrifugally spread the refrigerant across the inside of the outer circumferential wall (18) of the rotor. The spinning action, of course, occurs during normal use of the rotor.

The spinning rotor (10) is subject to frictional forces in normal use, as one of the rotor purposes is to provide a friction bearing surface to slow or stop an apparatus. As a frictional device, such as a pair of brake pads (60, 61), contacts the rotor (10) and exerts friction on either or both of the first and second faceplates (24, 25), the refrigerant (30) on the inside of the rotor's outer circumferential wall (18) absorbs the heat energy imparted to the rotor (10). By absorbing this heat energy, the refrigerant (30) cools the rotor.

The refrigerant (30) continues to absorb the heat until the refrigerant (30) reaches its vaporization temperature. Heat may continue to be added, but at a certain point, the refrigerant (30) absorbs all of the heat that the refrigerant can withstand in a liquid form. The refrigerant (30) then vaporizes inside the rotor. At this point, some of the heat energy absorbed from the rotor (10) is maintained within the vapor.

Of course, there is a limit as to how much energy the refrigerant (30) can absorb from the body of the brake rotor (10). Upon vaporizing all of the refrigerant possible at extreme temperature and pressure conditions inside the annular enclosure (15), the rotor body will escalate in temperature again. The invention herein, therefore, provides a method of continuously replenishing that portion of refrigerant (30) that is in a liquid form instead of a vapor form. The liquid refrigerant replenishes the heat sink to further reduce the temperature of the rotor body.

To replenish the amount of refrigerant (30) available in liquid form inside the rotor, the invention includes the step of condensing the vaporized refrigerant to a liquid by cooling the vaporized refrigerant. This step is possible because the heat energy within the vaporized refrigerant returns to cooler sections of the brake rotor (10) after the rotor has cooled in an ambient atmosphere. The refrigerant (30), therefore, absorbs the heat from the rotor (10), vaporizes, and then returns the heat within the vapor back to cooler sections of the annular enclosure (15) of the rotor body (10). The rotor (10) is exposed to ambient conditions that allow the returned heat to dissipate.

After returning the heat from the vaporized refrigerant back to the cooled rotor (10) and ultimately away from the rotor into the atmosphere, the vaporized refrigerant (30) condenses back to a liquid. The invention includes the step of centrifugally moving the condensed refrigerant back to the outer circumferential wall (18) of the rotor (10) by continuously spinning the rotor about its axis. In this fashion, the steps of vaporizing the refrigerant (30) and condensing the refrigerant (30) occur in a continuous heat transfer cycle.

The invented method regulates the maximum temperature that a heated surface, such as the faceplates (57, 58) of a brake rotor (43), will reach before establishing a heat transfer equilibrium condition with the refrigerant (30) inside the annular enclosure (15). The use of water as the refrigerant provides a good example. Placing water inside the rotor causes the temperature of the rotor (10) to peak around the boiling point of the water at the given pressure inside the rotor. The water inside the rotor (10) absorbs heat from friction until reaching the boiling point. The boiling point depends upon the pressure inside the rotor (10). Given that the inside of the rotor (10) is a closed system, the increased pressure increases the boiling point, allowing the liquid refrigerant to absorb more heat energy before boiling.

The method of cooling a rotor (10), as claimed herein, encompasses the cooling of any rotor that increases in temperature due to a frictional force applied from a frictional device. For example, in a traditional automotive braking system, the step of vaporizing the refrigerant (30) includes intermittently contacting a brake rotor (43) with a brake pad (60, 61). The term “intermittent” includes, but is not limited to, traditional automotive braking operations, where pressure is applied to the brake for a certain period and then released for a certain period. Similarly, the step of condensing the refrigerant encompasses periodically reducing the pressure of the brake pads (60, 61) in contact with the rotor (43) for a sufficient amount of time to cool the rotor (43) to a temperature below the condensation temperature of the vaporized refrigerant.

In another embodiment, the invention is a rotor temperature regulating system that includes a substantially annular enclosure (15) that spins around its axis. The annular enclosure (15) is at least partially hollow and houses a refrigerant (30) in the cavity of the annular enclosure (15). In normal operation, an adjustable frictional device contacts the annular enclosure (15) to change the rate at which the annular enclosure spins. The refrigerant (30) absorbs and then releases the frictional heat generated by contacting the annular enclosure (15) with the braking device, thereby limiting the maximum temperature of the annular enclosure (15).

The rotor temperature regulating system of this invention is readily applicable to any application in which a rotor (10) spins and contacts other parts, generating frictional heat. In a preferable embodiment, the rotor (10) is part of a traditional automotive braking system, wherein the annular enclosure (15) is a steel brake rotor (43).

The descriptions above regarding the rotor design, the cooling method, and the refrigerant details are equally applicable to this embodiment of a rotor temperature regulating system and will not be repeated herein. All of the details described above are incorporated as if fully set forth below.

The rotor temperature regulating system, described and claimed herein, provides a method of efficiently cooling a rotor subject to the heat of friction. To further assist in the cooling operation in an automotive context of disc brakes, a brake rotor temperature regulating system may further include a hat (45) connected to the inner flange (21) of a rotor. The hat conducts heat from the annular enclosure of the rotor (43). In this regard, the hat is another heat sink, allowing the frictional heat to dissipate from the brake rotor (43). A hat (45) according to this invention is shown in FIGS. 6 and 7 and includes fins (46) extending outwardly from the hat periphery.

The above described cooling method and temperature regulating system are applicable to any device in which temperature regulation is desirable. A temperature regulated device may be accomplished according to the invention herein by including a sealed, rotating enclosure made of a material capable of withstanding heat up to a critical temperature. Without limiting the invention, the critical temperature is defined as that temperature at which a material fails or has insufficient structural integrity for the use at hand.

A temperature regulated device, for purposes of this invention, has at least one surface subject to heat and a refrigerant sealed within the enclosure. As described above in the rotor context, the refrigerant sufficiently absorbs and releases the heat to prevent the enclosure temperature from reaching the critical temperature.

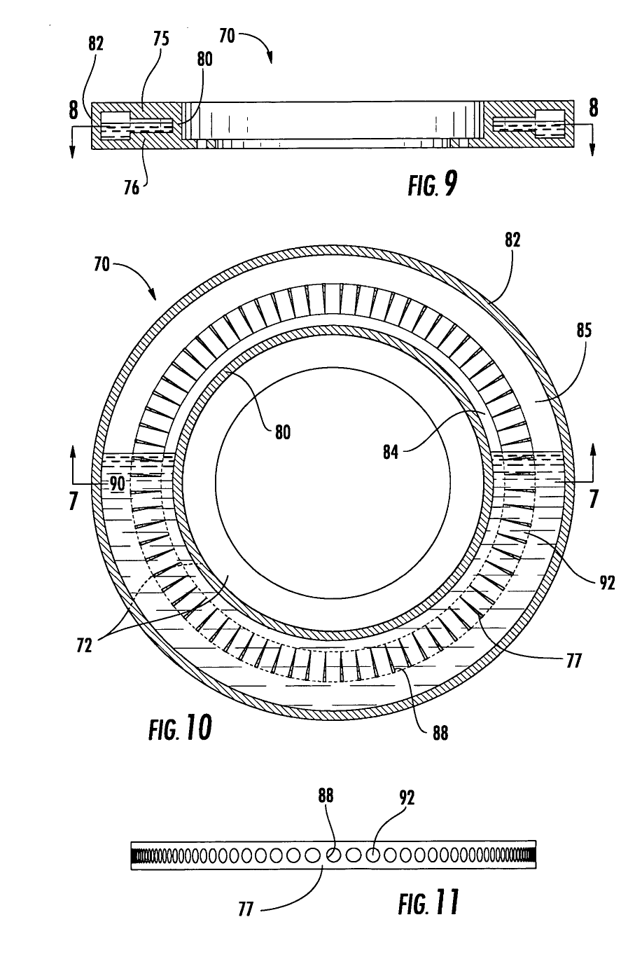

FIGS. 9-11 show yet another embodiment of a refrigerant-cooled rotor (70) for providing a friction-bearing surface. In this embodiment, the rotor (70) is a substantially annular enclosure (72) with a first faceplate (75) and a second faceplate (76) connected by an inner circumferential wall (80) and an outer circumferential wall (82). The rotor is at least partially filled with a refrigerant (90), preferably water.

In the embodiment of FIGS. 9-11, the inside of the annular enclosure (72) includes a solid transfer ring (77) connected to the first and second faceplates (75, 76) between the inner circumferential wall (80) and the outer circumferential wall (82). The transfer ring (77) defines an inner concentric hollow space (84) between the transfer ring (77) and the inner circumferential wall (80). An outer concentric hollow space (85) lies between the transfer ring (77) and the outer circumferential wall (82).

The transfer ring (77) further includes a plurality of pairs of inner edges (88, 89) defining hollow passages (92) from the inner hollow space (84) to the outer hollow space (85) within the annular enclosure (72). Other than the transfer ring (77) and the passages (92), the rotor (60) of FIGS. 7 and 8 has the physical attributes previously described for the entirely hollow annular enclosure. The descriptions above for other embodiments are incorporated into this embodiment as if fully set forth below.

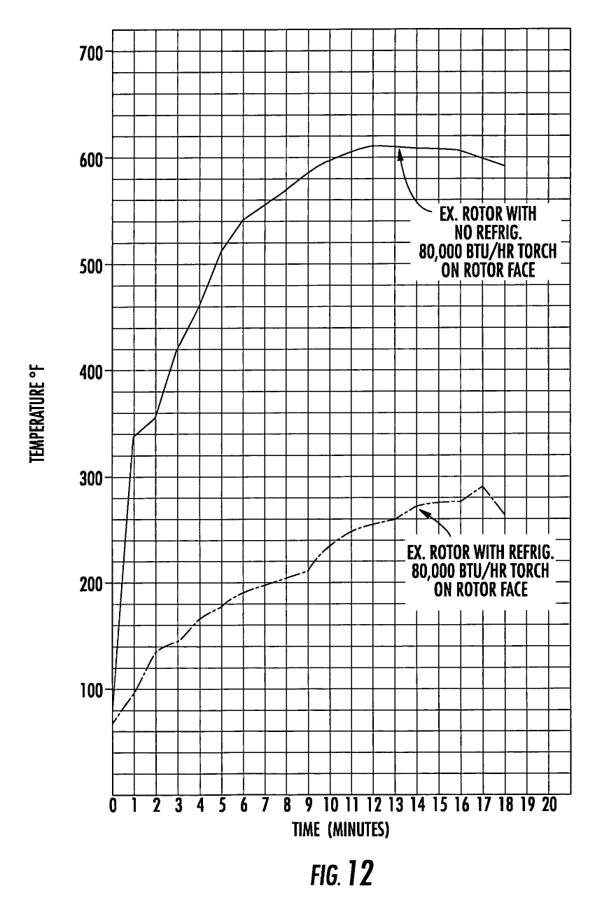

In the embodiment of FIGS. 9-11, the rotor is cooled upon the same principles previously discussed. The rotor (70) of FIGS. 9 and 10 includes the refrigerant (90), which is preferably water. The volume of refrigerant (90) in the rotor (70) is between about 50 percent and about 80 percent of the total hollow volume of the annular enclosure (72). In a more preferred embodiment, the volume of refrigerant (90) in the rotor (70) is between about 50 percent and about 65 percent of the volume of the overall hollow section.

In operation, the rotor (70) spins around the axis of the annular enclosure (72). The refrigerant (90) is pushed into the outer concentric hollow space (85) and against the outer wall (82) by centrifugal force. The faceplates of the rotor (75, 76) provide a friction bearing surface for contact with a braking device, such as the brake pads (60, 61) of FIG. 8.

As discussed above, the friction of the braking device heats the rotor (70). The refrigerant (90) absorbs the heat energy from the body of the annular enclosure (72), thereby providing a heat sink to cool the rotor (70). As the refrigerant (90) absorbs the heat energy, the temperature of the refrigerant (90) increases and eventually reaches the boiling point of the refrigerant. If the rotor (70) is continually exposed to the heat of friction or is intermittently heated without an opportunity for the rotor and the refrigerant to cool, the refrigerant will reach the vaporization temperature.

Although the inventors do not wish to be limited to any one theory of operation, upon vaporizing the refrigerant (90), a large portion of heat energy is maintained within the vaporized refrigerant instead of the friction bearing faceplates (75, 76) of the rotor. The vaporized refrigerant escapes the outer hollow space (85) of the annular enclosure (72) and enters the transfer ring (77) through bored passages (92).

The inner edges (88, 89) of the bored passages and the inner hollow space (84) provide a heat sink for the vaporized refrigerant. In this scenario, the vaporized refrigerant transfers the heat of friction back to the body of the annular enclosure (72), thereby cooling the vaporized refrigerant.

As discussed above, the rotor body is exposed to a cooler ambient atmosphere that allows the heat to ultimately dissipate away from the rotor (70). Upon sufficient cooling, the vaporized refrigerant condenses back to a liquid. The centrifugal force of the spinning rotor pushes the condensed refrigerant back to the outer hollow space (85). In this manner, the rotor and the refrigerant are kept in a continuous heat transfer cycle.

The transfer ring (77) shown in FIGS. 9 and 10 is also useful to provide structural support for the rotor (70). The body of the annular enclosure (72) may be solid metal that is machined to the desired configuration. Standard manufacturing methods allow the outer hollow space (85) to be formed from a solid annulus. After forming the outer hollow space (85), standard boring methods may be used to manufacture the passages (92). By boring the passages (92) so that the inner ends of the passages intersect, the inner hollow space (84) results. In other words, the ends of each bored passage (92) closest to the inner circumferential wall (80) intersect within the annular enclosure (72) to form the inner hollow space (84).

The method of cooling a rotor in accordance with the above disclosure has been tested according to the following examples.

### EXAMPLE 1

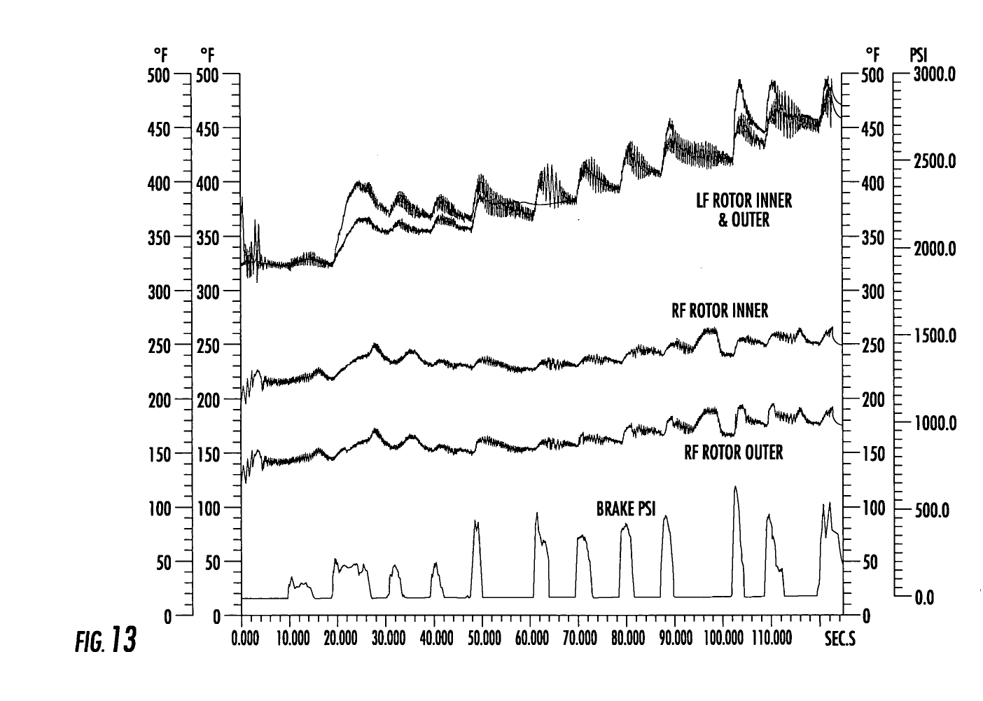

FIG. 12 shows the results of applying an 80,000 BTU/Hr torch on the faceplate of two rotors spinning in a room temperature ambient atmosphere. The rotors included the physical attributes of FIGS. 9-11 with a transfer ring as described above.

The first rotor had no refrigerant inside the annular enclosure.

The second rotor was filled with a refrigerant as described above. The refrigerant was water that filled the hollow portion of the rotor to about 80 percent capacity.

The rotor with no refrigerant inside the annular enclosure increased from room temperature to a maximum of about 610° F. in about 12.5 minutes in response to the 80,000 BTU/Hour torch on the rotor faceplate.

The refrigerant filled rotor increased to a maximum of only 290° F. after 17 minutes of exposure to the 80,000 BTU/Hour torch on the rotor faceplate.

### EXAMPLE 2

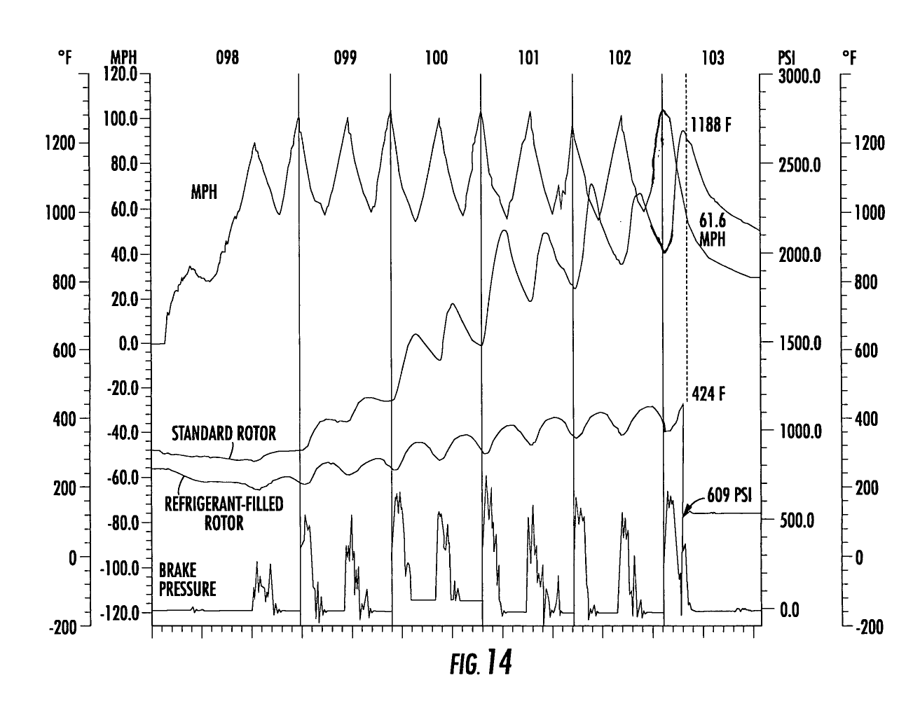

FIG. 13 shows the results of testing a rotor in accordance with the invention herein in a standard stock car driving 40 to 50 miles per hour on an in-line, straight track. A standard brake rotor with no refrigerant inside the annular enclosure was installed as the left front disc brake rotor. Two temperature sensors were applied to one faceplate of the standard rotor. A first temperature sensor was applied close to the inner circumferential wall on the rotor faceplate. A second temperature sensor was applied to the rotor faceplate closer to the outer circumferential wall.

A refrigerant-filled rotor according to the invention herein was installed as the right front disc brake rotor. Two temperature sensors were applied to one faceplate of the refrigerant filled rotor. A first temperature sensor was applied close to the inner circumferential wall (80) on the rotor faceplate (75). A second temperature sensor was applied to the rotor faceplate (75) closer to the outer circumferential wall (82).

The refrigerant-filled rotor included the transfer ring according to FIGS. 9-11 herein. The refrigerant inside the right front rotor was water that filled the hollow portion of the annular enclosure to about 60 percent capacity.

The braking patterns for the car are shown in terms of brake pressure applied during the driving test on the straight track.

The results show the cooling ability for a refrigerant-filled rotor according to the instant invention. The rotor body of the right front disc brake, which included the water as a refrigerant, increased in temperature much more slowly than the standard rotor. The average temperature for a standard rotor with no refrigerant ranged from about 320° F. to about 500° F. within two minutes. The average temperature for the refrigerant-filled rotor was significantly lower and ranged from about 170° F. to about 230° F. within two minutes.

### EXAMPLE 3

FIG. 14 shows the results of a test conducted on a standard stock race car with a standard rotor installed as one disc brake and a refrigerant-filled rotor installed as the other disc brake. The refrigerant filled rotor included the transfer ring as shown in FIGS. 9 and 10. The refrigerant was water that filled the annular enclosure of the rotor to about 80 percent capacity.

The car used to perform the test of this Example was approximately 200 pounds heavier than that of Example 2. The car was driven on a circular track at the speeds shown on the velocity line of FIG. 14. The braking patterns are shown in terms of brake pressure on FIG. 14.

The standard rotor escalated in temperature to a maximum of 1188° F. at a brake pressure of 609 psi.

The refrigerant filled rotor was more stable and reached a maximum of only 424° F. before the test was stopped.

In the the specification and the figures, typical embodiments of the invention have been disclosed. Specific terms have been used only in a generic and descriptive sense, and not for purposes of limitation. The scope of the invention is set forth in the following claims.

1. A method of cooling a rotor having a sealed annular cavity partially filled with a refrigerant, comprising:
spinning the rotor around its axis to centrifugally spread the refrigerant across the inside of the outer circumferential wall of the rotor;
vaporizing the refrigerant with heat generated by contacting the spinning rotor with a frictional device;
condensing the vaporized refrigerant to a liquid by cooling the vaporized refrigerant; and
centrifugally moving the condensed refrigerant back to the outer circumferential wall of the rotor by continuously spinning the rotor about its axis;
wherein the steps of vaporizing the refrigerant and condensing the refrigerant occur in a continuous heat transfer cycle.

2. The method of claim 1, wherein the step of vaporizing the refrigerant comprises contacting the rotor with a brake pad.

3. The method of claim 1, wherein the step of vaporizing the refrigerant comprises intermittently contacting the rotor with a brake pad.

4. The method of claim 1, wherein the step of condensing the refrigerant comprises reducing the pressure of the frictional device in contact with the rotor for a sufficient amount of time to cool a portion of the rotor to a temperature below the condensation temperature of the vaporized refrigerant.

5. The method of claim 1, wherein the step of condensing the vaporized refrigerant comprises exchanging heat between the vaporized refrigerant and the rotor.

6. The method of claim 1, wherein the continuous heat transfer cycle between the rotor and the refrigerant reduces the maximum temperature of the outside surface of the rotor.

7. A rotor temperature regulating system, comprising:
a substantially annular enclosure that spins around its axis;
a refrigerant inside said annular enclosure; and
an adjustable frictional device for contacting said annular enclosure to change the rate at which said annular enclosure spins,
wherein said refrigerant absorbs and then releases the frictional heat generated by contacting said annular enclosure with said frictional device, thereby limiting the maximum temperature of the annular enclosure.

8. A rotor temperature regulating system according to claim 7, wherein said refrigerant is water.

9. A rotor temperature regulating system according to claim 7, wherein the volume of said refrigerant is between about 50 percent and about 80 percent of the volume of said annular enclosure.

10. A rotor temperature regulating system according to claim 7, wherein said annular enclosure is made of metal.

11. A rotor temperature regulating system according to claim 7, wherein said annular enclosure is a brake rotor.

12. A rotor temperature regulating system according to claim 7, wherein said annular enclosure is connected to a spindle that rotates said annular enclosure around its axis.

13. A rotor temperature regulating system according to claim 7, wherein said annular enclosure comprises a first faceplate and a second faceplate connected by an inner circumferential wall and an outer circumferential wall, wherein at least one of said first and second faceplates contacts said frictional device.

14. A rotor temperature regulating system according to claim 13, wherein said outer circumferential wall is contoured to increase surface area.

15. A rotor temperature regulating system according to claim 7, further comprising an inner flange connected substantially perpendicularly to said inner circumferential wall.

16. A rotor temperature regulating system according to claim 15, further comprising a hat connected to said inner flange, wherein said hat conducts heat from said annular enclosure.

17. A rotor temperature regulating system according to claim 16, wherein said hat comprises fins extending from the outer periphery of said hat.

18. A rotor temperature regulating system according to claim 7, wherein said annular enclosure is exposed to the ambient atmosphere for cooling.

19. A brake rotor for providing frictional contact with a braking device, comprising:
a substantially annular enclosure comprising a first faceplate and a second faceplate connected by an inner circumferential wall and an outer circumferential wall, said annular enclosure being at least partially hollow; and
a refrigerant inside said annular enclosure.

20. A brake rotor according to claim 19, wherein the volume of said refrigerant is between about 50 percent and about 80 percent of the volume of said annular enclosure.

21. A brake rotor according to claim 19, wherein the radius of said outer circumferential wall is less than the radius of said first and second faceplates.

22. A brake rotor according to claim 19, wherein said outer circumferential wall is connected to said first and second faceplates by a reinforced weld.

23. A brake rotor according to claim 19, wherein the outer edges of said first and second faceplates are contoured to increase surface area.

24. A brake rotor according to claim 19, wherein said outer circumferential wall is contoured to maximize surface area.

25. A brake rotor according to claim 19, wherein said refrigerant comprises water.

26. A brake rotor according to claim 19, wherein said annular enclosure is made of steel.

27. A brake rotor according to claim 19, wherein at least one of said first and second faceplates comprises at least one air groove.

28. A rotor consisting of a hollow, substantially annular enclosure partially filled with a refrigerant.

29. A rotor according to claim 28 wherein said refrigerant is water.

30. A rotor according to claim 28, wherein the volume of said refrigerant is between about 50 percent and about 80 percent of the volume of said annular enclosure.

31. A rotor according to claim 28, wherein said annular enclosure is made of steel.

32. A rotor for providing contact with a frictional device, comprising:
a substantially annular enclosure comprising a first faceplate and a second faceplate connected by an inner circumferential wall and an outer circumferential wall;
a transfer ring connected to said first and second faceplates between said inner circumferential wall and said outer circumferential wall, said transfer ring defining an inner hollow space between said transfer ring and said inner circumferential wall and an outer hollow space between said transfer ring and said outer circumferential wall, said transfer ring further having a plurality of inner edges defining hollow passages from the inner hollow space to the outer hollow space within said annular enclosure; and
a refrigerant inside said annular enclosure.

33. A rotor according to claim 32, wherein the volume of said refrigerant is between about 50 percent and about 80 percent of the volume of the hollow portion of said annular enclosure.

34. A rotor according to claim 32, wherein said refrigerant comprises water.

35. A rotor according to claim 32, wherein said annular enclosure is made of a metal.

36. A rotor according to claim 32, wherein said annular enclosure is made of steel.

37. A rotor according to claim 32, wherein at least one of said first and second faceplates comprises at least one air groove.

38. A rotor for contacting a frictional device, comprising:
a hollow, substantially annular enclosure comprising a first faceplate and a second faceplate connected by an inner circumferential wall and an outer circumferential wall; and
water inside said annular enclosure.

39. A temperature-regulated device, comprising:
a sealed, rotating enclosure made of a material capable of withstanding heat up to a critical temperature;
at least one surface subject to heat; and
a refrigerant sealed within said enclosure, wherein said refrigerant sufficiently absorbs and releases the heat to prevent the temperature of said enclosure from reaching the critical temperature.
